(19) United States
(12) Patent Application Publication
(10) Pub. No.: US 2008/0004815 A1
(43) Pub. Date: Jan. 3, 2008

(54) PARTICLE COUNTER

(75) Inventors: AKINORI TAKEDA, TOKYO (JP); TSUTOMU NAKAJIMA, TOKYO (JP); YASUTAKA NAKAJIMA, TOKYO (JP); YUKIHIRO KIMOTO, TOKYO (JP)

Correspondence Address: LEE FREDRIC SHARRA, 4313 TROUTHAVEN DRIVE, MURRYSVILLE, PA, 15668, US

(73) Assignee: RION CO., LTD., TOKYO (JP)

(21) Appl. No.: 11/777,333

(22) Filed: Jul. 13, 2007

(30) Foreign Application Priority Data
Feb. 25, 2005 (JP) 2005-050490

(51) Int. Cl. G06F 19/00

(52) U.S. Cl. 702/26; 702/128; 702/1; 702/22; 702/23; 702/127; 382/100

(57) ABSTRACT

A particle counter for measuring the number of floating particles contained in a sample to determine the particle concentration therein comprises: a memory section 11 for storing a discrete value C per unit of time based on the maximum particle number concentration set in the specification in advance; an operation processing section 12 for comparing a discrete value M per unit of time to be actually counted to the discrete value C per unit of time stored in the memory section 11; and an output section 4 for outputting the information based on the comparison results of the operation processing section 12.

### BACKGROUND OF THE INVENTION

1. Field of the Invention

The present invention relates to a particle counter for measuring the number of floating particles contained in a sample.

2. Description of the Prior Art

In an automatic particle counter of a light scattering type, a phenomenon referred to as “counting loss” occurs, whereby the number of particles is undercounted even when there are many particles in a sample to be measured. This counting loss is caused when a large number of particles pass at one time through a particle detecting area formed by irradiating light.

The generation of such counting loss causes the counting accuracy to deteriorate. In order to prevent against the deterioration of the counting accuracy, a standard (JIS B9921) is set for the light scattering type automatic particle counter, whereby the counting loss must be, for example, 5% or less in the maximum particle number concentration.

In the case of actual measurement using a conventional light scattering type automatic particle counter, an operator must continue to monitor whether the particle concentration of the sample is high or low by reading a discrete value of the particle counter. When the particle concentration is higher than the maximum particle number concentration, the operator has recognized that the present discrete value is counted as less than the actual number of particles (that is, the condition in which the counting loss prescribed in JIS B9921 is higher than 5% in the maximum particle number concentration).

However, in measuring operation using the conventional particle counter, there is a problem in that the burden imposed on the operator is great because he always has to continue to monitor the discrete value displayed by the particle counter and has to judge whether or not the counting loss is higher than 5% in the maximum particle number concentration.

### SUMMARY OF THE INVENTION

It is therefore an object of the present invention to provide an improved particle counter which can solve the problems stated above and whereby an operator is not required to continuously monitor a discrete value, and therefore the operator's burden can be reduced.

In order to attain this object, according to a first aspect of the present invention, a particle counter for measuring the number of floating particles contained in a sample to determine the particle concentration therein comprises: a memory section for storing a discrete value C per unit of time based on the maximum particle number concentration set in the specification in advance; an operation processing section for comparing a discrete value M per unit of time, to be actually counted, to the discrete value C per unit of time stored in the memory section; and an output section for outputting the information based on the comparison results of the operation processing section.

According to a second aspect of the present invention, a particle counter according to the first aspect is provided, in which the memory section is adapted to store the discrete value C per unit of time based on the maximum particle number concentration which is provided for each particle size classification and corresponds to each particle size classification.

According to a third aspect of the present invention, the particle counter according to the first aspect or the second aspect is provided, in which the output section is provided to issue a warning alarm in the case where the discrete value M per unit of time is higher than the discrete value C per unit of time.

### BRIEF DESCRIPTION OF THE DRAWINGS

The above and other objects, features and advantages of the present invention will become more apparent from the following description when taken in conjunction with the accompanying drawings.

FIG. 1 is a schematic diagram of a particle counter according to the present invention; and

FIG. 2 is a flow chart showing the operation of the particle counter according to the present invention.

### DETAILED DESCRIPTION OF THE PREFERRED EMBODIMENTS

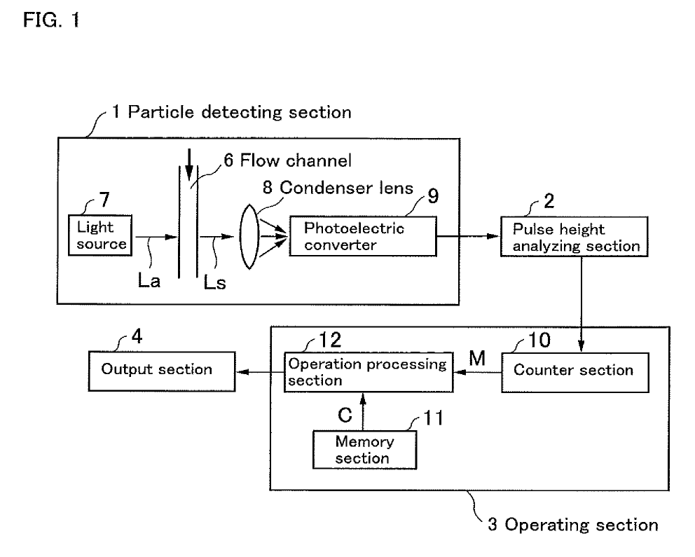

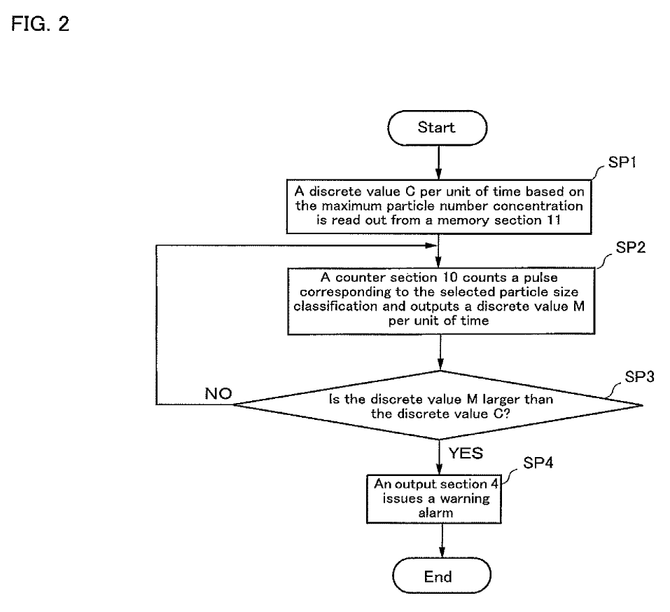

A preferred embodiment of the present invention will now be described with reference to the accompanying drawings. FIG. 1 is a schematic diagram of a particle counter according to the present invention and FIG. 2 is a flow chart showing the operation of the particle counter.

A particle counter according to the present invention comprises, as shown in FIG. 1, a particle detecting section 1 for detecting particles contained in a sample by using light, a pulse height analyzing section 2 for trapping the particles of every particle size classification, an operating section 3 for carrying out operation taking counting loss into consideration, and an output section 4 for outputting the processing results of the operating section 3.

The particle detecting section 1 comprises a flow channel 6 for the flow of a sample, a source of light 7 for irradiating a laser beam La onto the flow channel 6 to form a particle detecting area, a condenser lens 8 for condensing a scattered light beam Ls emitted from the particles passing through the particle detecting area, and a photoelectric converter 9 for converting the light condensed by the condenser lens 8 to the voltage corresponding to the intensity of the light.

The pulse height analyzing section 2 receives the output signals of the particle detecting section 1 and outputs the signals above a predetermined level as a particle of a particle size corresponding to the level according to the particle size classification.

The operating section 3 comprises a counter section 10 for receiving the output signals of the pulse height analyzing section 2 to count the pulses corresponding to the particle size classification, a memory section 11 for storing a discrete value C per unit of time based on the maximum particle number concentration set in the specification in advance, and an operation processing section 12 for comparing an actual discrete value M per unit of time, output by the counter section 10, to the discrete value C per unit of time stored by the memory section 11.

In the instance of the particle counter of which the particle size classification is one, the discrete value C per unit of time based on the maximum particle number concentration of such a particle size classification can be stored in the memory section 11. In the case of the particle counter of which the particle size classification is two or more, the discrete value C per unit of time based on the maximum particle number concentration of only the minimum particle size classification can be stored in the memory section 11 or the discrete value C per unit of time based on the maximum particle number concentration of all the particle size classifications can also be stored therein.

In the case where, as the comparison results by the operation processing section 12, the actual discrete value M per unit of time is higher than the discrete value C per unit of time, the operation processing section 12 inputs signals that an alarm will be issued into the output section 4. The output section 4 then issues an audible and visible warning alarm. The output section 4 displays the discrete value M per unit of time irrespective of the comparison results by the operation processing section 12.

Operation of the particle counter, as constructed above, according to the present invention will now be described with reference to a flow chart as shown in FIG. 2. Shown in the flow chart is the case where the particle counter of which the particle size classification is two or more and the discrete value C per unit of time based on the maximum particle number concentration of all the particle size classifications is stored in the memory section 11.

First, in a step SP1, when the particle size classification is selected to start measurement, the operation processing section 12 reads out the discrete value C per unit of time based on the maximum particle number concentration corresponding to the particle size classification found in advance to be stored in the memory section 11.

Next, in a step SP2, the counter section 10 receives the output signals of the pulse height analyzing section 2, counts the pulse corresponding to the selected particle size classification, and outputs a discrete value M per unit of time.

Then, in a step SP3, the operation processing section 12 compares the actual discrete value M per unit of time output from the counter section 10 to the discrete value C per unit of time read out from the memory section 11. In the case where the actual discrete value M per unit of time is lower than the discrete value C per unit of time from the comparison results of the operation processing section 12, the program proceeds to a step SP2, and in the situation where the actual discrete value M per unit of time is higher than the discrete value C per unit of time, the program proceeds to a step SP4.

In the step SP4, when the operation processing section 12 inputs the signals that an alarm will be issued into the output section 4, the output section 4 issues an audible and visible warning alarm.

In the case where the output section 4 has issued the warning alarm, the operator stops measurement and takes necessary action such as replacement of the current particle counter with a particle counter which is more suitable for the material being measured.

### EFFECTS OF THE INVENTION

As described above, according to the first aspect of the present invention, an operator is not required to continuously monitor the discrete value and the operator's burden can be reduced because information for judging whether or not the particle concentration to be measured is higher than the maximum particle number concentration is output. Reliability of particle counting operation also improves because there is no possibility that the data indicating large counting loss is accepted.

According to the second aspect of the present invention, reliability of the particle counting operation improves because the maximum particle number concentration is set for each particle size classification and there is less possibility that the data indicating large counting loss will be accepted.

According to the third aspect of the present invention, the operator can immediately recognize that counting loss has occurred and can take prompt action because a warning alarm is issued in the case where the particle concentration to be measured is higher than the maximum particle number concentration.

### INDUSTRIAL APPLICABILITY

In the case where the particle concentration to be measured is higher than the maximum particle number concentration, the warning alarm is automatically issued. An operator is therefore not required to further continuously monitor a discrete value and his burden can be lightened. Further, since there is no possibility that the data indicating large counting loss will be accepted, reliability of the particle counting operation improves.

What is claimed is:

1. A particle counter for measuring the number of floating particles contained in a sample to determine a particle concentration therein comprising: a memory section for storing a discrete value C per unit of time based on a maximum particle number concentration set in a specification in advance; an operation processing section for comparing a discrete value M per unit of time to be actually counted to the discrete value C per unit of time stored in the memory section; and an output section for outputting information based on comparison results of the operation processing section.

2. The particle counter according to claim 1, wherein the memory section stores the discrete value C per unit of time based on the maximum particle number concentration which is provided for each particle size classification and corresponds to each particle size classification.

3. The particle counter according to claim 1, wherein the output section issues a warning alarm when the discrete value M per unit of time is higher than the discrete value C per unit of time.

4. The particle counter according to claim 2, wherein the output section issues a warning alarm when the discrete value M per unit of time is higher than the discrete value C per unit of time.
